(19) United States
(12) Patent Application Publication
(10) Pub. No.: US 2003/0008593 A1
(43) Pub. Date: Jan. 9, 2003

(54) Method and device for evaporating a getter material in a vacuum tube

(76) Inventors: Ben Heinz Hageluken, Eindhoven (NL); Henricus Johannes Josephus Catharina Meijer, Eindhoven (NL); Hendrik Kroesbergen, Eindhoven (NL)

Correspondence Address: U.S. Philips Corporation, 580 White Plains Road, Tarrytown, NY, 10591, US

(21) Appl. No.: 10/180,407

(22) Filed: Jun. 26, 2002

(30) Foreign Application Priority Data
Jun. 27, 2001 (EP) 01202465.9

(51) Int. Cl. H01J 9/38

(52) U.S. Cl. 445/19

(57) ABSTRACT

Method for evaporating a getter material in a vacuum tube, comprising a step of providing a high frequency induction coil on the outside of the vacuum tube, near the location of the holder of the getter material, and passing an alternating current through the high-frequency induction coil for evaporating the getter material. The alternating current is generated by a high-frequency generator with a variable frequency. The induction coil and a capacitor are jointly incorporated in a resonant circuit. During execution of the evaporating step, the frequency of the high-frequency generator is attuned to the resonant frequency of the LC resonator. The dissipated power in the getter material in the holder is then determined from the power delivered by the high-frequency generator and the dissipated power in the LC resonator. The dissipated power can be controlled by adjusting the total power of the high-frequency generator.

The invention relates to a method for evaporating a getter material in a vacuum tube, in the main comprising the steps of

(i) providing a vacuum tube provided with a holder containing a getter material to be evaporated

(ii) providing a high frequency induction coil on the outside of the vacuum tube at the location of the holder, and

(iii) passing an alternating current generated by a high-frequency generator having a tunable frequency through said high-frequency induction coil for a predetermined period of time for dissipating power in the holder containing the getter material for the purpose of evaporating said getter material.

Such a method is generally known in the production of vacuum tubes in which a getter is used for adsorbing gases being released in said tube, both during the production and during the life of a respective tube. A holder containing a getter material, usually, but not exclusively so, a mixture of BaAl₄ and Ni, is mounted on an inner wall of the tube prior to the evacuation of the vacuum tube. After the tube has been sealed and evacuated, the getter material is heated (to a temperature of about 800° C. for BaAl₄ and Ni ) by means of a high-frequency induction coil arranged on the outside of the tube, after which the getter material undergoes an exothermal reaction while emitting light, as a result of which the adsorbing component is released from the getter material and preferably precipitates in a uniformly distributed manner on the inner walls of the tube. (In the case of BaAl₄ and Ni, Ba is released whilst NiAl is formed in the holder).

From U.S. Pat. No 5,433,638 a method of manufacturing a getter-containing vacuum tube is known. According to said method, the getter material is heated in a first step, during which the largest possible first temperature increase as a function of time takes place, until the start of an exothermal reaction of the getter material, which can be recognized by the fact that light is being emitted, and the getter material is further heated in a next step, during which the temperature rises only slightly or remains substantially constant, until sufficient time has passed to fully release the adsorbing component from the getter material and deposit it on the inner wall of the tube in question. The object of this method is to reduce the production time without running the risk of the holder for the getter material becoming too hot, and melting, owing to the fact that the temperature increase takes place too quickly.

One drawback of the known method is the fact that information on the course of the evaporation process of the getter material is only obtained to a limited extent. It is possible to determine whether an exothermal reaction is being started, but it is not possible to determine to what extent said exothermal reaction is continued or, in other words, how much of the adsorbing component is being released from the getter material. The partial release of the adsorbing component implies a limitation of the life of the tube in question, which limitation cannot be determined, however, in the production stage according to the prior art.

Another drawback of the known method is the fact that a relatively large portion of the power delivered by the generator is not used for evaporating the getter material but is dissipated in the generator itself and in the supply lines to the high-frequency coil, which thus need to be fitted with water-cooling.

Another drawback of the known method is the fact that it becomes more difficult to use as the wall thickness of the vacuum tube increases at the location of the holder containing the getter material. In the case of CRTs, the wall thickness is larger as the tube is flatter and larger.

It is an object of the invention to present a method for evaporating a getter material in a vacuum tube, which makes it possible to determine in real-time whether the exothermal reaction for evaporating getter material is being started and to what extent an exothermal reaction is continued once it has started.

Furthermore it is an object of the invention to present such a method according to which a larger part of the power generated by the required high-frequency generator is used effectively for evaporating the getter material, so that it will no longer be necessary for the generator and the supply lines to be water-cooled.

Another object of the invention is to present a method according to which getter material can be evaporated without any difficulty in vacuum tubes having relatively thick walls.

These objects are achieved by a method as described in the opening paragraph, which method is characterized according to the invention in that the induction coil to be provided in step (ii) is incorporated in a circuit together with a capacitor, forming an LC resonant circuit, and in that the frequency of the high-frequency generator is attuned to the resonant frequency of the LC resonant circuit during the execution of step (iii), and in that the dissipated power in the holder containing the getter material is determined.

The LC resonant circuit in which the induction coil according to the invention is incorporated serves as a storage medium for the power to be transferred to the holder containing the getter material. As soon as a maximum amount of power is stored in the LC resonant circuit, the generator need not deliver more power than is necessary for compensating the power that is being withdrawn from the LC resonant circuit.

In an embodiment of a method according to the invention, the dissipated power in the holder containing the getter material is determined from the total power delivered by the high-frequency generator and the dissipated power in the LC resonant circuit.

According to the invention, the total power delivered by the high-frequency generator is determined, for example, by means of a first multiplier circuit for real-time determination of the product of the output current and the output voltage of the generator.

According to the invention, the dissipated power in the LC resonant circuit is determined, for example, by means of a second multiplier circuit in combination with a divider circuit for real-time determination of the quotient of the square of the output voltage of the generator and a voltage drop across the LC resonant circuit imposed by a dc voltage source.

When carrying out a method according to the invention, the high-frequency generator is advantageously connected to the LC resonant circuit by means of a low-inductance coaxial cable, water-cooling not being required.

In yet another embodiment of a method according to the invention, the method comprises the step (iv) of determining, by means of an optical sensor and time measuring means, the time during which getter material evaporates from the holder while emitting light that can be detected by means of said sensor, which step (iv) is carried out prior to step (iii).

In this embodiment, double monitoring of the evaporation process takes place, and the determination of the power input for the evaporation process is combined with a “visual” inspection by means of said optical sensor.

The invention furthermore relates to a device for evaporating a getter material in a vacuum tube in accordance with a method according to the invention described above.

The invention will be explained in more detail hereinafter by means of embodiments, in which reference is made to the drawing.

In the drawing:

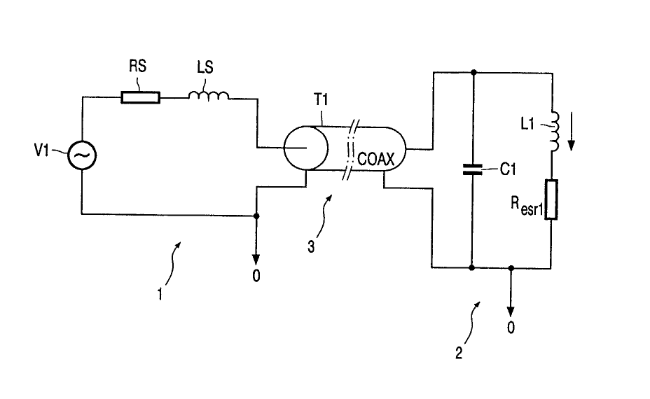

FIG. 1 shows a strongly simplified circuit diagram of a high-frequency generator and a high-frequency induction coil for evaporating a getter material according to the invention.

FIG. 1 shows an equivalent-circuit diagram for a generator 1, represented by ac voltage source V₁, series resistor Rₛ and series inductance Lₛ, which is connected, by means of a coaxial cable 3, to an LC resonant circuit 2 comprising a high-frequency induction coil with inductance L₁, an effective series resistor Rₑₛᵣ₁ and a parallel capacitor C₁. The coil L₁ is held against the outer side of a vacuum tube, in a manner which is known per se, at the location of a holder containing getter material which is mounted on the inner side. In order to cause the getter material to evaporate, the frequency of the generator 1 is attuned to the frequency of the LC resonant circuit 2, so that the generator 1 only needs to deliver power which dissipates in the LC resonant circuit 2 in the effective series resistor Rₑₛᵣ₁ and the parallel capacitor C₁ of the induction coil L₁. The distance between the coil L₁ and the capacitor C₁ is kept as short as possible, so that it will suffice to use a simple, low-inductance coaxial cable 3 for the connection between the generator 1 and the LC resonant circuit 2. According to the invention, the power dissipated in the holder containing the getter material (hereinafter referred to as the getter) is determined in order to monitor and control the evaporation process of the getter material. A simple determination of the voltage across the LC resonant circuit 2 will not suffice for this determination, however, because damping of the coil L₁ by the getter depends on the distance from the coil L₁ to the getter, and on the correct orientation of the getter with respect to the coil L₁. According to the invention, the dissipated power in the getter (P_{getter}) is determined from the total power (P_{gen}) delivered by the high-frequency generator 1 and the power (P_{LC}) dissipated in the LC resonant circuit 2, in accordance with

P_{getter}=P_{gen}−P_{LC} (1)

The combination of coil L₁ and capacitor C₁ forms an LC resonant circuit 2 having a high quality factor Q, so that the voltage across said resonant circuit 2 and the current through the coaxial cable 3 are both sinusoidal and separated in phase by substantially 90°, at the resonant frequency of said circuit 2, so that the generator current is mainly determined by the series inductance Lₛ and the voltage across it. The LC resonant circuit 2 is connected to the generator 1 via a second self-inductance L₂. The second self-inductance L₂ carries a small portion of the circuit current, which lags the circuit voltage by 90°. The second self-inductance L₂ is connected in parallel to the coil L₁ in this equivalent-circuit diagram, and together they form the inductive portion of the LC resonant circuit 2. Because the LC resonant circuit 2 is not lossless, a so-termed parallel loss resistance can be defined, which represents all the losses of the LC resonant circuit 2. In that case said parallel loss resistance is connected in parallel to the LC resonant circuit 2 that is now assumed to be ideal. The current delivered by the generator 1 so as to cause the LC resonant circuit 2 to oscillate is a sinusoidal current. The current is in phase with the voltage across the LC resonant circuit 2 and is determined by the magnitude of the parallel loss resistance. Said parallel loss resistance depends on the physical resistances of the inductances L₁ and L₂ and the polarization loss and/or the effective coil resistance Rₑₛᵣ₁ of the capacitor C₁. A second parallel loss resistance is used in this exemplary description as soon as a conducting object withdraws power from the LC resonant circuit 2 by means of a connection to the LC resonant circuit 2. The second parallel loss resistance is connected in parallel to the LC resonant circuit 2. The current through the second parallel loss resistance, which is delivered by the generator 1, is in phase with the circuit voltage. The product of the current through the second parallel loss resistance and the voltage across the LC resonant circuit 2 is the useful power delivered by the generator 1.

In the case that the generator frequency does not correspond exactly to the frequency of the LC resonant circuit 2, higher harmonics will be present in the generator current. In that case the generator 1 will deliver a capacitive current or an inductive current, depending on the frequency, the value of which current may be much higher, depending on the detuning, than that of the real additional current required for maintaining the voltage in the LC resonant circuit 2. Other harmonics in the LC resonant circuit 2 are generated when the generator does not generate a harmonic voltage. In order to keep the generator losses small, it is preferred to use a square-wave voltage. The power P_{gen} delivered by the generator 1, which is determined by means of a multiplier circuit from the real-time product of the output current and the output voltage from the generator, is as follows

P_{gen}=I_{Rm}*Vₒᵤₜ (2)

In this equation, I_{Rm} is the current through the output resistor Rₘ of the generator 1.

In order to determine the dissipated power P_{LC} in the LC resonant circuit 2, the current through said circuit and the voltage across said circuit can be measured, and subsequently the product of the measured values can be determined. The real-time product represents the dissipated power in the LC resonant circuit 2. The voltage can easily be determined by measuring the output voltage Vₒᵤₜ of the generator 1. In order to be able to measure the current through the LC resonant circuit 2, it is necessary to connect a current sensor in series with the coil L₁ and the capacitor C₁, the internal resistance of which current sensor is limited to an impracticably low value, however, in order to keep the losses in said current sensor at a negligibly low level.

By way of alternative to the current measurement, the embodiment of the method according to the invention makes use of the already existing resistive value of the coil L₁. The dissipated power P_{LC} in the coil L₁ is obtained from the equation

P_{LC}=I²_{Resr1}*Rₑₛᵣ₁ (3)

The current i_{Resr1} through the coil L₁, which can be calculated from the voltage V_{LC} across the coil L₁, which equals the quotient of the ac voltage Vₒᵤₜ across the coil L₁ and the impedance of the coil L₁, which is mainly determined by the inductance L₁ at the resonant frequency Fₒ that is being used, is as follows

i_{Resr1}=Vₒᵤₜ/2ΠFₒL₁ (4)

The effective coil resistance Rₑₛᵣ₁ depends on the temperature of the coil and the operating frequency. As a result of the skin effect, which depends on the shape of the coil L₁ and the ratio between the section and the diameter of the coil windings, the resistance increases in proportion to the frequency above a particular frequency. In the case of a tuned coil, at a fixed frequency and a constant ac amplitude, the skin factor, which is defined as the ratio between the dc resistance and the ac resistance (the effective loss resistance at the frequency F₀), is a constant, which can be determined for each LC resonant circuit. The effective coil resistance Rₑₛᵣ₁ is thus obtained from

Rₑₛᵣ₁=R_{esr1, dc}_{_{·}}* skin-factor(Fₒ) (5)

The dc resistance R_{esr1,dc} can be determined by connecting a dc source in series with the high-frequency generator 1, which can be realized in a simple manner because the latter is provided with an output transformer. In that case the quotient of the dc voltage V_{LC, dc} across the coil L₁ and the direct current I_{dc} through the coil L₁ represents the dc resistance R_{esr1 dc} as follows

R_{esr1,} _{^{dcC}}=V_{LC,} _{^{dC/}}I_{dc} (6)

Substitution of the equations (4), (5) and (6) in (3) yields the value of the dissipated power in the getter, in accordance with

P_{getter}=I_{Rm}*Vₒᵤₜ−(Vₒᵤₜ/2ΠFₒL₁)²*I_{dc}/skin-factor(Fₒ)*V_{LC} _{^{dc}} (7)

As equation (7) shows, determination of the dissipated power in the getter is only possible if an analog first multiplier circuit is available, which generates an instantaneous signal for real-time determination of the product of the output current and the output voltage of the generator 1, and a second multiplier circuit combined with a divider circuit for generating an instantaneous signal which is proportional to the power loss in the tuned LC resonant circuit 2.

By using an LC resonant circuit 2 having a high quality factor and a high-frequency generator 1 which precisely follows the natural resonance of the LC resonant circuit 2, the dissipated power in the connecting cable can be disregarded, and the resulting value of the dissipated power in the getter P_{getter} is substantially independent of variations in the position of the getter and the distance between the getter and the high-frequency induction coil.

1. A method for evaporating a getter material in a vacuum tube, in the main comprising the steps of
(i) providing a vacuum tube provided with a holder containing a getter material to be evaporated
(ii) providing a high frequency induction coil on the outside of the vacuum tube at the location of the holder, and
(iii) passing an alternating current generated by a high-frequency generator having a tunable frequency through said high-frequency induction coil for a predetermined period of time for dissipating power in the holder containing the getter material for the purpose of evaporating said getter material, characterized in that the induction coil (L₁) to be provided in step (ii) is incorporated in a circuit together with a capacitor (C₁), forming an LC resonant circuit (2), and in that the frequency of the high-frequency generator (1) is attuned to the resonant frequency of the LC resonant circuit (2) during the execution of step (iii), and in that the dissipated power in the holder containing the getter material is determined.

2. A method as claimed in claim 1, characterized in that the dissipated power in the holder containing the getter material is determined from the total power delivered by the high-frequency generator (1) and the dissipated power in the LC resonant circuit (2).

3. A method as claimed in claim 2, characterized in that the total power delivered by the high-frequency generator (1) is determined by means of a first multiplier circuit for real-time determination of the product of the output current and the output voltage of the generator (1).

4. A method as claimed in one of the claims 2-3, characterized in that the dissipated power in the LC resonant circuit (2) is determined by means of a second multiplier circuit in combination with a divider circuit for real-time determination of the quotient of the square of the output voltage of the generator and a voltage drop across the LC resonant circuit (2) imposed by a dc voltage source.

5. A method as claimed in any one of the preceding claims, characterized in that the high-frequency generator (1) is connected to the LC resonant circuit (2) by means of a low-inductance coaxial cable (3).

6. A method as claimed in any one of the preceding claims, characterized in that said method comprises the step of
(iv) determining, by means of an optical sensor and time measuring means, the time during which getter material evaporates from the holder while emitting light that can be detected by means of said sensor, which step (iv) is carried out prior to step (iii).

7. A device for evaporating a getter material in a vacuum tube in accordance with a method as claimed in any one of the preceding claims.
